(19) United States
(12) Patent Application Publication
(10) Pub. No.: US 2018/0135568 A1
(43) Pub. Date: May 17, 2018

(54) ELECTRIC SUPERCHARGER

(71) Applicant: KABUSHIKI KAISHA TOYOTA JIDOSHOKKI, Kariya-shi (JP)

(72) Inventors: Makio OSHITA, Aichi-ken (JP); Toshihiro YAMAMICHI, Aichi-ken (JP)

(73) Assignee: KABUSHIKI KAISHA TOYOTA JIDOSHOKKI, Kariya-shi (JP)

(21) Appl. No.: 15/808,946

(22) Filed: Nov. 10, 2017

(30) Foreign Application Priority Data
Nov. 15, 2016 (JP) 2016-222181

(51) Int. Cl. F02M 26/03; F02M 26/09

(52) U.S. Cl. CPC F02M 26/03; F02M 26/09

(57) ABSTRACT

An electric supercharger includes an electric motor, a compressor wheel rotated by the electric motor, and a compressor housing. The compressor housing includes a first passage through which air is introduced, an introducing port connecting to an EGR device, a second passage through which at least one of air and EGR gas is flowed, a bypass passage through which at least one of air and EGR gas is flowed, and a bypass valve to open and close the bypass passage. When the bypass valve is opened, air introduced from the first passage and EGR gas introduced from the introducing port are flowed through the bypass passage to the internal combustion engine. When the bypass valve is closed, air introduced from the first passage and EGR gas introduced from the introducing port are compressed in the compressor wheel and flowed through the second passage to the internal combustion engine.

### BACKGROUND OF THE INVENTION

The present invention relates to an electric supercharger,

Japanese Patent Application Publication No. 2008-38869 discloses a multistage supercharging type exhaust turbocharger.

The above turbocharger has a high-pressure compressor cover that is formed as an integrated compressor cover incorporating therein a compressor inlet passage for intake air and a bypass inlet passage having an opening and closing part operated by the compressor bypass valve device.

In an internal combustion engine having a conventional supercharger of another structure. EGR gas, or part of gas exhausted from the internal combustion engine, is allowed to flow through an EGR device into an intake passage in which intake air flows upstream of the supercharger so that a mixture of the intake air and the EGR gas is compressed by the supercharger and supplied to the internal combustion engine. However, an internal combustion engine having such a supercharger has a problem in that the intake passage becomes large in size and it is difficult to install the EGR device in a vehicle because the joining portion of the EGR device is provided separately from the supercharger.

The present invention which has been made in light to the above problem is directed to providing an electric supercharger that is easily installed in a vehicle.

### SUMMARY OF THE INVENTION

In accordance with an aspect of the present invention, there is provided an electric supercharger including an electric motor, a compressor wheel rotated by the electric motor, and a compressor housing accommodating the compressor wheel. The compressor housing includes a first passage through which air is introduced, an introducing port connected to an EGR device that recirculates EGR gas that is part of exhaust gas of an internal combustion engine to an intake passage, a second passage through which at least one of air and EGR gas that are compressed in the compressor wheel is flowed to the internal combustion engine, a bypass passage through which at least one of air and EGR gas before being compressed in the compressor wheel is flowed to the internal combustion engine without being flowed through the compressor wheel, and a bypass valve to open and close the bypass passage. When the bypass valve is opened, air introduced from the first passage and EGR gas introduced from the introducing port are flowed through the bypass passage to the internal combustion engine. When the bypass valve is closed, air introduced from the first passage and EGR gas introduced from the introducing port are compressed in the compressor wheel and flowed through the second passage to the internal combustion engine.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a system chart of a drive system having an electric supercharger according to a first embodiment of the present invention;

FIG. 2 is a plan view of the electric supercharger of FIG. 1;

FIG. 3 is a front view of the electric supercharger as seen in the direction of the arrow III in FIG. 2;

FIG. 4 is a right side view of the electric supercharger as seen in the direction of the arrow IV in FIG. 2;

FIG. 5 is a sectional view taken along the line V-V of FIG. 4;

FIG. 6 is a sectional view taken along the line VI-VI of FIG. 5;

FIG. 7 is a sectional view taken along the line VII-VII of FIG. 2; and

FIG. 8 is a system chart of a drive system having an electric supercharger according to a second embodiment of the present invention.

### DETAILED DESCRIPTION OF THE EMBODIMENTS

The following will describe embodiments of the present invention with reference to the accompanying drawings. Same or like parts are designated by the same reference numerals, and the description thereof will not be reiterated.

### First Embodiment

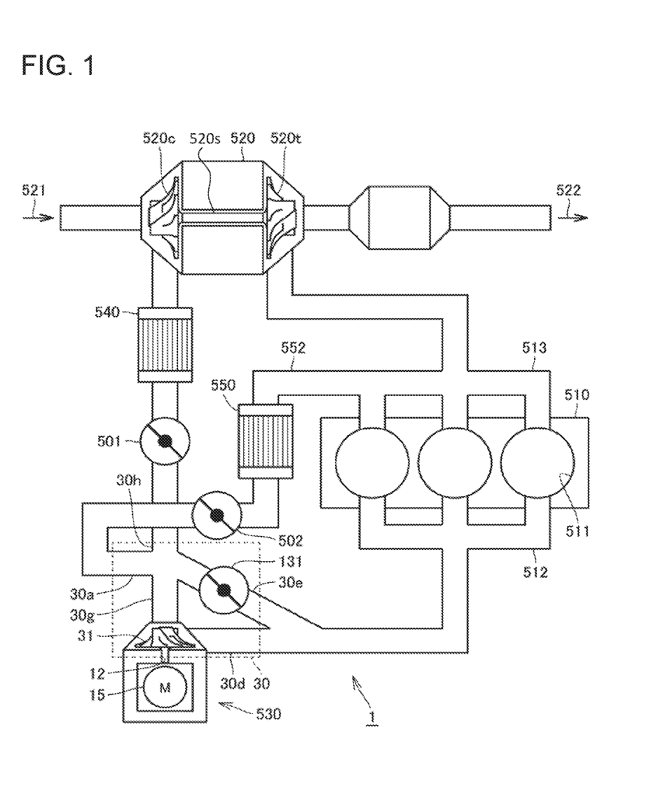

The following will describe an electric supercharger 530 of a drive system 1 according to a first embodiment of the present invention with reference to FIGS. 1 to 7. Referring to FIG. 1, the drive system 1 includes an engine 510, a turbocharger 520 that is powered by exhaust gas of the engine 510 to compress intake air, and an electric supercharger 530 that further compresses the intake air sent from the turbocharger 520.

The turbocharger 520 includes a shaft 520s, a compressor wheel 520c and, a turbine wheel 520t. The compressor wheel 520c and the turbine wheel 520t are mounted on the shaft 520s at the opposite ends thereof for rotation therewith. As the turbine wheel 520t is rotated by exhaust gas, its rotation is transmitted to the compressor wheel 520c through the shaft 520s, so that the compressor wheel 520c is rotated. Air introduced in the direction of the arrow 521 is compressed by the compressor wheel 520c.

An intercooler 540 is provided downstream of the compressor wheel 520c with respect to the direction in which the air flows. The intercooler 540 cools the air that is heated by adiabatic compression by the compressor wheel 520c thereby to increase the density of the air.

An electronic throttle device 501 is provided downstream of the intercooler 540. When the engine 510 is a gasoline engine, the electronic throttle device 501 controls the amount of intake air to control the output power of the engine 510. When the engine 510 is a diesel engine, the valve in the electronic throttle device 501 is opened in normal operation. When exhaust gas recirculation (EGR) is performed under a light load condition or when it is desired to increase the exhaust gas temperature by reducing the intake air in the operation to regenerate a diesel particulate filter (DPF), the electronic throttle device 501 is operated to reduce the opening of its valve.

An electric supercharger 530 is provided downstream of the electronic throttle device 501. The electric supercharger 530 includes an electric motor 15, a shaft 12 connected at one end thereof to the electric motor 15, a compressor wheel 31 connected to the other end of the shaft 12, and a compressor housing 30 having therein a plurality of air passages.

The engine 510 is provided downstream of the electric supercharger 530. Air is supplied through an intake manifold 512 into each cylinder bore 511 of the engine 510. Exhaust gas is generated by combustion of fuel in the cylinder bores 511 supplied with air. The exhaust gas generated in the cylinder bores 511 are discharged through an exhaust manifold 513 to an exhaust pipe by movement of the pistons. An EGR device 552 is connected to the exhaust manifold 513 and includes an EGR valve 502 and an EGR cooler 550. When the EGR valve 502 is opened, part of exhaust gas discharged from the cylinder bores 511 to the exhaust manifold 513, or the EGR gas, is flowed to the EGR cooler 550 of the EGR device 552 to be cooled there and then introduced to the compressor housing 30. EGR gas which has the same chemical composition as exhaust gas from the engine 510 is flowed through the compressor housing 30 to the engine 510. EGR gas has no oxygen or very small amount of oxygen, if any. Therefore, when EGR gas is flowed into a combustion chamber, fuel is burnt under low oxygen condition in the combustion chamber, so that the peak combustion temperature is decreased accordingly. As a result, generation of nitrogen oxides is suppressed. The remaining part of exhaust gas discharged from the cylinder bores 511 to the exhaust manifold 513 is flowed through an exhaust pipe to the turbocharger 520 to rotate the turbine wheel 520t and then discharged to the atmosphere as indicated in the direction of the arrow 522 through a purification apparatus not shown.

The compressor housing 30 has therein an air passage 30h serving as the first passage of the present invention, an EGR passage 30a serving as the introducing port of the present invention, a compressor inlet passage 30g, a compressor outlet passage 30d serving as the second passage of the present invention, a bypass passage 30e, and a bypass valve 131

Air is introduced into the electric supercharger 530 through the air passage 30h. EGR gas is introduced into the electric supercharger 530 through the EGR passage 30a. When the bypass valve 131 is closed, no air and no EGR gas are allowed to flow through the bypass passage 30e. When the bypass valve 131 is opened, air and EGR gas are allowed to flow through the bypass passage 30e.

At least one of the air and the EGR gas is introduced through the compressor inlet passage 30g to the compressor wheel 31. While the compressor wheel 31 is rotating, at least one of the air and the EGR gas is compressed by the compressor wheel 31 and discharged through the compressor outlet passage 30d.

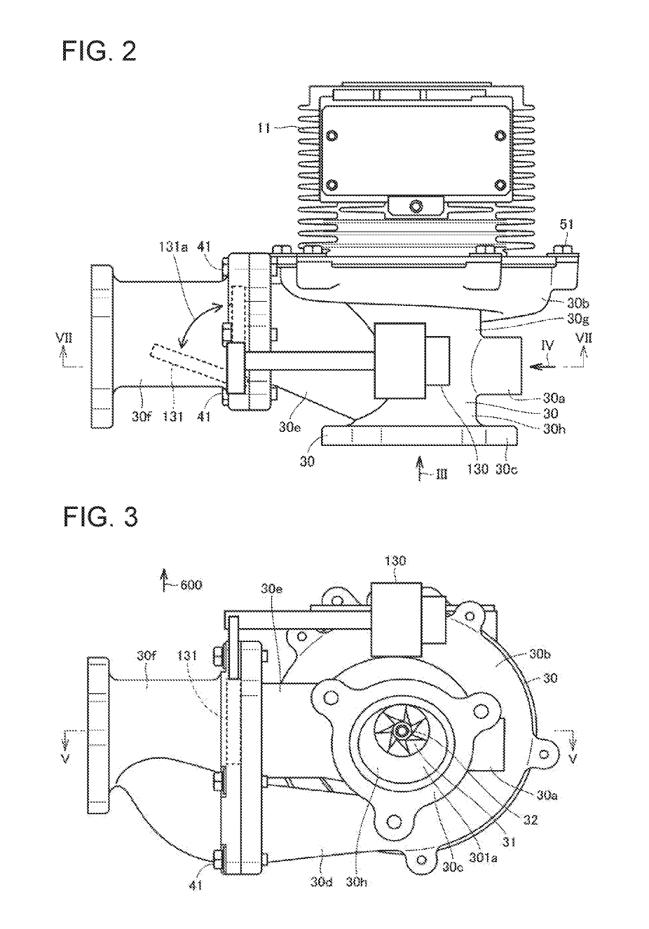

Referring to FIG. 2, there is shown the compressor housing 30 of the electric supercharger configured to have therein a plurality of passages. The compressor housing 30 has a flange 30c which is connected to a pipe through which air is taken in. The air passage 30h is provided downstream of the flange 30c.

The EGR passage 30a is connected to the air passage 30h. The EGR passage 30a is connected to a pipe through which EGR gas is taken in. The EGR passage 30a is joined with the air passage 30h.

The compressor inlet passage 30g is provided downstream of the air passage 30h and the EGR passage 30a. Air supplied from the air passage 30h and EGR gas supplied from the EGR passage 30a are mixed and flowed to the compressor inlet passage 30g.

A scroll passage 30b is formed in a spiral shape around a rotating shaft of the compressor wheel 31, through which gas compressed by the compressor wheel 31 is flowed,

The bypass passage 30e is connected to the air passage 30h and the EGR passage 30a. The bypass valve 131 is connected to the bypass passage 30e.

When the bypass valve 131 is opened, at least one of the air and the EGR gas is flowed through the bypass passage 30e. When the bypass valve 131 is closed, at least one of the air and the EGR gas is flowed to the compressor wheel 31.

The compressor housing 30 includes an actuator 130. The actuator 130 electrically controls to open and close the bypass valve 131 and adjusts the opening degree of the bypass valve 131.

The motor housing 11 is fixed to the compressor housing 30 by bolts 51. An outlet passage 30f is fixed to the compressor housing 30 by bolts 41.

Referring to FIG. 3, the scroll passage 30b has such a spiral shape that its passage diameter is increased toward the connection thereof with the cutlet passage 30f.

The bypass passage 30e is disposed with the inlet opening thereof facing the EGR passage 30a along the extending direction of the EGR passage 30a so that EGR gas supplied through the EGR passage 30a is smoothly flowed via the air passage 30h into the bypass passage 30e. Accordingly, when the bypass valve 131 is opened, EGR gas is easy to flow from the EGR passage 30a to the bypass passage 30e.

The outlet passage 30f is connected to both the bypass passage 30e and the compressor outlet passage 30d, The outlet passage 30f has such a bifurcated shape that the above two passages are joined with each other.

The compressor outlet passage 30d having a straight shape is connected to the downstream-most portion of the scroll passage 30b.

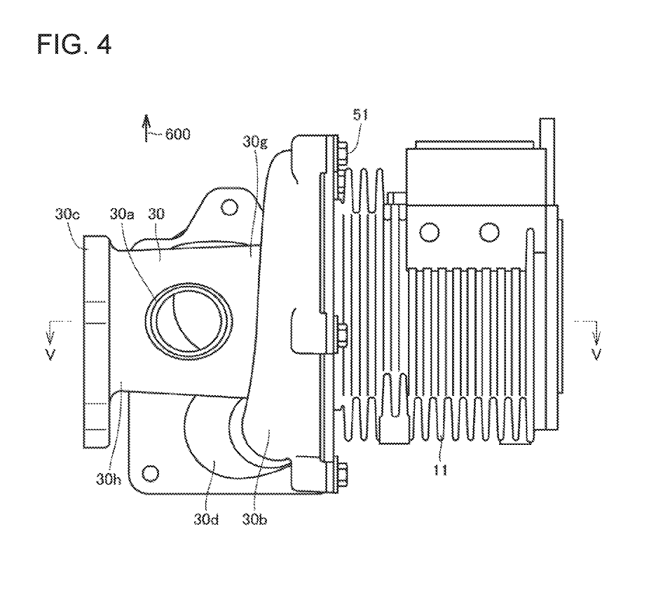

Referring to FIG. 4, the EGR passage 30a having a cylindrical shape is connected to the air passage 30h and the compressor inlet passage 30g.

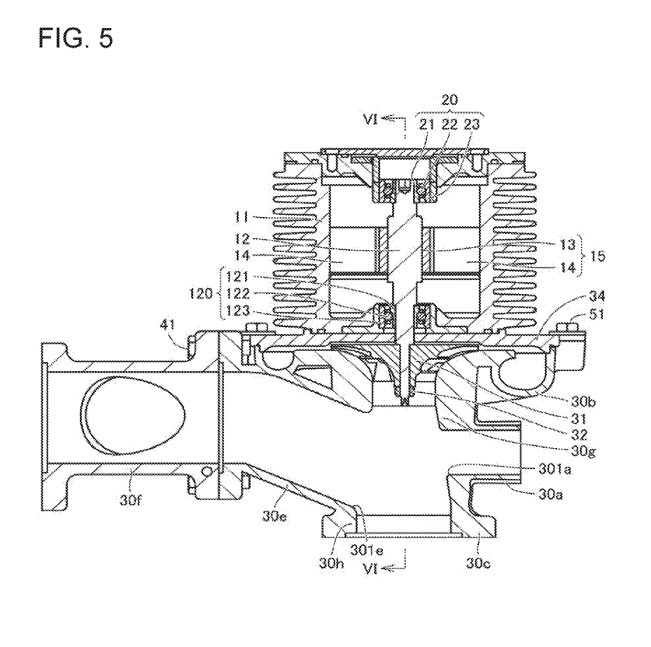

Referring to FIG. 5, the electric motor 15 includes a rotor 13 fixed on a shaft 12 and a stator 14 disposed facing the rotor 13. The electric motor 15 is supplied with electric power and drives to rotate the shaft 12.

The shaft 12 extends from one end thereof to the other end thereof. The shaft 12 is rotatably supported at one end thereof by a bearing 20 and at one other end thereof by a bearing 120 in the motor housing 11. The shaft 12 has a stepped shape having a plurality of different diameter portions in the longitudinal direction thereof.

The rotor 13 is fixed on the thickest portion of the shaft 12. When the electric motor 15 is a three-phase AC motor, the rotor 13 includes a core and a permanent magnet that is embedded in the core.

The bearings 20, 120 are provided on the shaft 12 on the opposite sides of the rotor 13. The bearings 20, 120 are provided by ball bearings. Each of the bearings 20, 120 includes an inner race 21, 121 disposed in contact with the shaft 12, the outer race 23, 123 disposed facing the inner race 21, 121, a plurality of balls 22, 122 disposed between the inner race 21, 121 and the outer race 23, 123 as the rolling element, and a retainer retaining the balls 22, 122.

The compressor wheel 31 is fixed on the other end of the shaft 12 and compresses intake air. Intake air including the air and the EGR gas is drawn in from the air passage 30h by the rotation of the compressor wheel 31. The flowing speed of the intake air flowing through the compressor wheel 31 is increased by the centrifugal force of the rotating compression wheel 31 and the pressure of the intake air is increased in the diffuser portion of the compressor housing 30 and the scroll passage 30b, accordingly.

A plate 34 is provided between the compressor wheel 31 and the motor housing 11. The plate 34 is disposed on the back side of the compressor wheel 31 and fixed to the compressor housing 30 by the bolts 51. The plate 34 has at the center thereof a hole through which the shaft 12 is inserted. The plate 34 and the compressor housing 30 cooperate to form the diffuser portion and the scroll passage 30b.

The compressor housing 30 is provided so as to cover the compressor wheel 31. The compressor housing 30 has therein the compressor inlet passage 30g. At least one of the air and the EGR gas is introduced through the compressor inlet passage 30g to the compressor wheel 31 to be compressed in the compressor wheel 31 and flowed to the compressor outlet passage 30d.

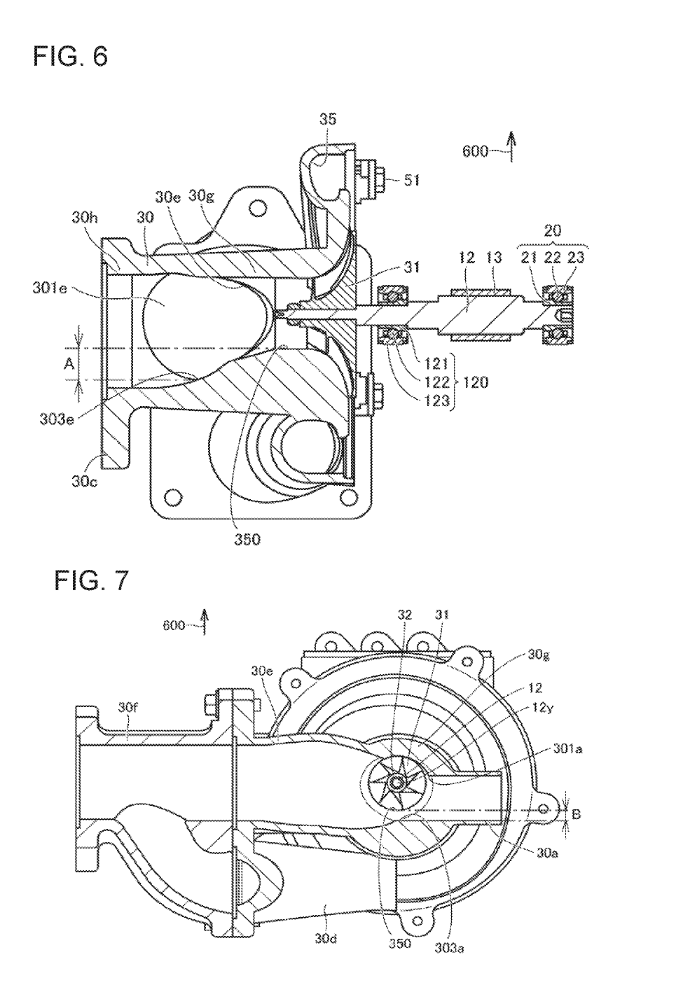

Referring to FIG. 6, in which illustration of the stator 14 and the motor housing 11 around the shaft 12 are omitted, the lower end 303e of the inlet 301e in the bypass passage 30e is offset vertically downward relative to the lower end 350 of the inlet side opening of the compressor wheel 31 by a distance which is indicated by A.

The arrow 600 shown in FIG. 6 and other similar drawings indicates the upper direction. The downward offset of the bypass passage 30e makes difficult for moisture in the bypass passage 30e to flow toward the compressor inlet passage 30g, which helps to prolong the serviceable life of the electric supercharger.

Referring to FIG. 7, the lower end 303a of the EGR passage 30a is offset vertically downward relative to the lower end 350 of the inlet side opening of the compressor wheel 31 by a distance which is indicated by B.

The exhaust gas supplied to the EGR device may contain moisture. If EGR gas flows through the introducing port toward the compressor wheel, the moisture that has a greater specific gravity than the other components contained in the EGR gas hardly flows toward the compressor wheel because of the vertical downward offset of the introducing port of EGR gas relative to the lower end of the inlet side opening of the compressor wheel, with the result that the mixture of moisture and intake air is suppressed.

The downward offset of the EGR passage 30a makes difficult for moisture of the EGR passage 30a to flow toward the compressor inlet passage 30g, which helps to prolong the serviceable life of the electric supercharger.

In the present embodiment, the EGR passage 30a is shown having a predetermined length. However, it may be so configured that the length of the EGR passage 30a is shorter or, alternatively, substantially zero so that only the introducing port 301a exists. In this case, a pipe is inserted in the introducing port 301a so that EGR gas is supplied through the pipe to the introducing port 301a. In the present embodiment, the shaft 12 of the supercharger 530 has a plurality of different diameter portions. However, the shaft 12 may be formed with a constant diameter.

The electric supercharger 530 includes the compressor wheel 31 rotatable by the electric motor 15 and the compressor housing 30 accommodating the compressor wheel 31. The compressor housing 30 has therein the air passage 30h through which air is introduced, the EGR passage 30a connected to the EGR device 552 that recirculates EGR gas, or part of the exhaust gas generated by the engine 510 to an intake passage, the compressor outlet passage 30d through which at least one of the air and the EGR gas compressed by the compressor wheel 31 is flowed to the engine 510, the bypass passage 30e through which at least one of the air and the EGR gas before being compressed is flowed to the engine 510 without being flowed through the compressor wheel 31, and the bypass valve 131 that opens and closes the bypass passage 30e. When the bypass valve 131 is opened, the air introduced from the air passage 30h and the EGR gas introduced through the EGR passage 30a are allowed to flow to the engine 510 via the bypass passage 30e. When the bypass valve 131 is closed, the air introduced from the air passage 30h and the EGR gas introduced through the EGR passage 30a are compressed by the compressor wheel 31 and allowed to flow to the engine 510 via the compressor outlet passage 30d. Since the air passage 30h, the EGR passage 30a, and the bypass passage 30e are provided in the singular compressor housing 30, the structure of parts other than the compressor housing 30 can be simplified and, therefore, the installation of the electric supercharger 530 to the engine 510 may be facilitated as compared with a structure having no compressor housing such as 30.

The lower end 303a of the EGR passage 30a is offset vertically downward relative to the lower end 350 of the inlet side opening of the compressor wheel 31, which prevents water in the EGR passage 30a from flowing toward the compressor wheel 31.

The lower end 303e of the inlet 301e of the bypass passage 30e is offset vertically downward relative to the lower end 350 of the inlet side opening of the compressor wheel 31. Therefore, water in the EGR passage 30a is prevented from flowing toward the compressor wheel 31.

### Second Embodiment

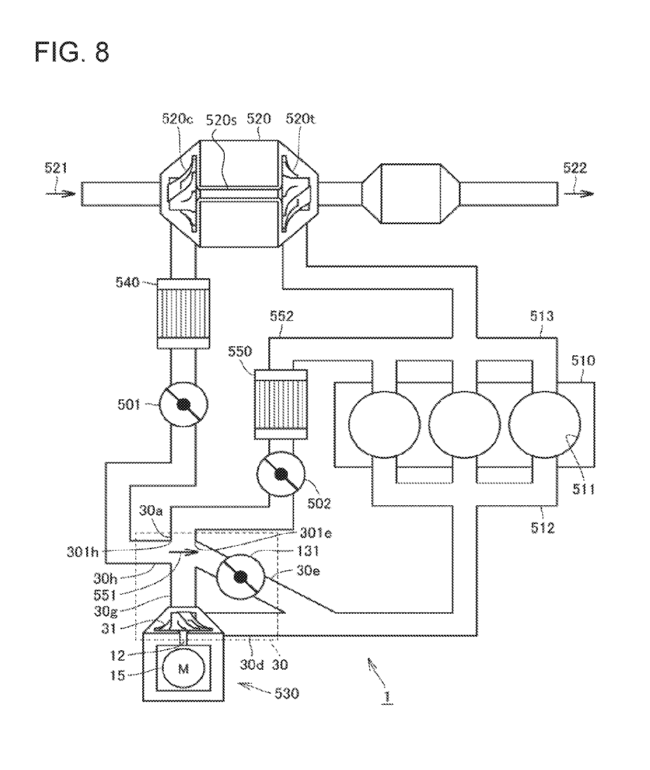

Referring to FIG. 8, there is shown an electric supercharger 530 according to a second embodiment of the present invention. The second embodiment differs from the first embodiment in that the air passage 30h is provided in the compressor housing 30 so as to face the inlet 301e of the bypass passage 30e in the extending direction of the air passage 30h. As with the first embodiment, the lower end 303a of the EGR passage 30a is offset vertically downward relative to the lower end 350 of the inlet side opening of the compressor wheel 31. The lower end 303e of the inlet 301e of the bypass passage 30e is also offset vertically downward relative to the lower end of the 350 of the inlet side opening of the compressor wheel 31.

In the electric supercharger 530 according to the second embodiment, air is flowed from the air passage 30h to the bypass passage 30e in the direction of the arrow 551 in a nearly straight manner, so that the resistance of air flowing from the air passage 30h to the bypass passage 30e and hence the air intake resistance can be reduced.

The present examples and embodiments are to be construed as illustrative and not restrictive, and the invention is not to be limited to the details given herein but may be modified within the scope of the present invention.

The present invention can be is applicable to an electric supercharger mounted on a vehicle.

What is claimed is:

1. An electric supercharger comprising:
an electric motor;
a compressor wheel rotated by the electric motor; and
a compressor housing accommodating the compressor wheel, wherein the compressor housing includes a first passage through which air is introduced, an introducing port connected to an EGR device that recirculates EGR gas that is part of exhaust gas of an internal combustion engine to an intake passage, a second passage through which at least one of air and EGR gas that are compressed in the compressor wheel is flowed to the internal combustion engine, a bypass passage through which at least one of air and EGR gas before being compressed in the compressor wheel is flowed to the internal combustion engine without being flowed through the compressor wheel, and a bypass valve to open and close the bypass passage, wherein when the bypass valve is opened, air introduced from the first passage and EGR gas introduced from the introducing port are flowed through the bypass passage to the internal combustion engine, and wherein when the bypass valve is closed, air introduced from the first passage and EGR gas introduced from the introducing port are compressed in the compressor wheel and flowed through the second passage to the internal combustion engine.

2. The electric supercharger according to claim 1, wherein a lower end of the introducing port is offset vertically downward relative to a lower end of an inlet side opening of the compressor wheel.

3. The electric supercharger according to claim 1, wherein a lower end of an inlet of the bypass passage is offset vertically downward relative to the lower end of the inlet side opening of the compressor wheel.

4. The electric supercharger according to claim 1, wherein the first passage is provided in the compressor housing so as to face an inlet of the bypass passage in an extending direction of the first passage.
